(19) United States
(12) Patent Application Publication
(10) Pub. No.: US 2004/0044639 A1
(43) Pub. Date: Mar. 4, 2004

(54) Programmable data logger

(76) Inventors: Andreas Schoenberg, Karlsruhe (DE); Wolfgang Bassenauer, Griesheim (DE)

Correspondence Address: PERKINS COIE LLP, P.O. BOX 2168, MENLO PARK, CA, 94026, US

(21) Appl. No.: 10/299,214

(22) Filed: Nov. 18, 2002

(30) Foreign Application Priority Data
Nov. 22, 2001 (DE) 101 57 188.7

(51) Int. Cl. G06F 7/00

(52) U.S. Cl. 707/1

(57) ABSTRACT

The invention relates to apparatuses and methods for logging information on at least one bus system, particularly a CAN system, having an interface to the bus system, which interface can be used to analyse data traffic on the bus system, having a processing unit which filters determinable data from the data traffic in order to store these data in a memory, having a communications unit which permits wireless communication in order, preferably, to transmit the data stored in the memory, and having a housing, where the housing and the containing components are of such a size that mobile use, particularly in a motor vehicle, is possible.

### DESCRIPTION

1. Technical Field of the Invention

The invention relates to an apparatus and a method for logging information on at least one bus system.

In very involved motor vehicles of more and more complex design, it will in future be unavoidable to use bus systems which are employed for communicating with the individual modules. The use of bus systems reduces the number of cables and hence the complexity of the wiring harness enormously. This is accompanied by the fact that the vehicles can be designed to be lighter and hence to have lower consumption.

The use of bus systems is also susceptible to faults, however. The increasing complexity means that it is often not possible for simulations to give a comprehensive result. This means that the vehicles need to be subjected to longer tests in order to identify faults which a simulation would not have picked up.

These tests involve checking the vehicle's functions by analysing the bus system. Should faults occur, then it is advantageous for the bus traffic to have been recorded over a relatively long period of time. The ascertained data can then be used to draw a conclusion about the origin of the fault.

2. Prior Art

DE 35 40599 discloses a diagnostic system for a motor vehicle. The diagnostic system is connected to a serial bus. The fault reports are stored in a non-volatile memory. The fault reports can be read from the defined memory areas of the control system and can be displayed on the display system. Diagnosis is initiated in this case by plugging in a diagnostic plug.

DE 3229411 discloses a self-monitoring apparatus. This system comprises a memory area for storing fault data and fault addresses, a fault display and a microcomputer which is associated with the control system and has an input and a display unit. This system is relatively involved, however, and requires a special vehicle information system with a separate display and input unit. In addition, if the system is intended to be used to monitor a plurality of electronic control systems, then a dedicated bus system from the vehicle information system to the respective control system is required in each case.

### BACKGROUND OF THE INVENTION

It is an object of the invention to provide a diagnostic system for bus systems, particularly for the CAN bus, which can be used on a variable basis and makes it possible to analyse a multiplicity of faults.

This object is achieved by inventions having the features of the independent claims. Advantageous developments of the inventions are characterized in the subclaims.

A first element of the present invention is an apparatus for logging information on at least one bus system, particularly in a CAN system. CAN systems are used in the field of motor vehicles on account of their particular advantages, such as determinism, reliability and performance. An interface to the bus system can be used to access the data traffic.

A processing unit, which is preferably in the form of a microprocessor, filters determinable data from the data traffic. The data are determined by a program which has been compiled prior to this. Specific program constructs can stipulate what data need to be filtered. The data filtered in this way are stored in a memory. This memory is an FIFO memory which is regularly in the range of one to two MB. Other sizes are likewise conceivable, but it will be pointed out that a large amount of data makes evaluation more complex. The FIFO memory can likewise be simulated by an appropriate memory management system using a RAM store. In preferred embodiments, a plurality of separate FIFO memories are provided.

Use in motor vehicles entails the inventive apparatus being fitted at locations which do not inconvenience the occupants. To read the collected data, it is advantageous if the data can be transmitted via a wireless connection. For this task, the present invention has a communications unit which permits wireless communication in order to transmit the data stored in the memory. Besides the data transmitted in this manner, it is likewise possible to transmit program information which has resulted in the memory being frozen. Hence, it is also possible to access internal states of the examining program which determines the state of the memory.

For use in motor vehicles, the apparatus is arranged in an impact-resistant and sealed housing. In this context, the housing is of a size which does not hinder use in the vehicle. It is generally a box having the size of a shoe box The components are of power-saving design, which means that the supply voltage can be provided by the vehicle. For this purpose, appropriate connections are provided which are connected to a power supply unit.

In order for the collected information which the apparatus records during the vehicle's trips to be automatically transmitted to a central control station which evaluates the data, the communications unit examines the surroundings for possible reception stations. These reception stations are connected to computing centres which analyse the transmitted data.

It is beneficial if communication takes place by radio using UMTS, GSM, GRPS, Bluetooth, Wireless Lan or using infrared. Standard protocols have the advantage that the infrastructure is inexpensive, since it is either already present or is mass-produced. In the preferred embodiment, wireless LAN is used on account of the high bandwidth.

Another element of the invention is an apparatus for mobile logging of information on at least one bus system, particularly in a CAN system, whose processing unit uses programmable filter rules to filter out data in order to store these data in a memory. On the basis of programmable states and events, the state of the memory is frozen. A program which controls such an apparatus comprises two components. In the first component, the filter rules are stipulated. The filter rules stipulate what information is to be stored later for analysis. The events stipulate when the memory needs to be frozen. On account of its being in the form of an FIFO, the memory would lose its content if it could not be frozen by particular events. These events are generally triggered by particular states on the bus system, particular reports from the users of the bus system and/or by internal states of the program which are derived from the previous history. These states and events are described by an appropriate programming language, the finished program being transferred, following compilation, to the inventive apparatus, where it is then executed. It will be pointed out that it is likewise possible to interpret the program. In the preferred embodiment, however, no use is made of this. This is not intended to represent any restriction of the scope of protection, however.

The program can thus be divided into two sections which, depending on type, can be executed either in parallel or sequentially. Should there be a multiprocessor system available, then each section can be executed as a process on a dedicated processor. In single-processor systems, at least sections of the process are generally executed sequentially. The first section of the program undertakes the filtering of the data and determines what data need to be written to the memory. The second process controls the first by checking events and states which can result in the content of the memory being deleted or frozen.

The states or events are variables, timers, counters, timeouts, flags, message rates, time integrals, reception events and time-controlled events which use functions such as conditions or logic or arithmetic operators to control start or stop events which affect the first process. To store particular states and events, data structures are provided which can undertake the task of variables after they have been instantiated.

The filtering system comprises recording filters, reproduction filters and gateway filters which include or exclude data having particular identifiers. The recording filter determines the data which are stored in the memory during analysis. The reproduction filter is used to find the data which will be transmitted later. Gateway filters are useful only if there are a plurality of CAN buses, and stipulate what data are forwarded from one bus to the other.

For better analysis of the collected data, said data are provided with a time stamp, so that synchronous reproduction is possible. During reproduction, the packets are resent on the bus in order to be able to observe and analyse the fault situation which has arisen as often as desired.

To transmit the program, a separate interface is preferably used. This can be in the form of serial interfaces. In one particular embodiment, the program is likewise transmitted via the wireless connection. It is thus possible to create a new program which is not transmitted until the inventive apparatus sets up a connection to the base station. This connection is often not set up until the vehicle containing the inventive apparatus enters the reception range of the base station.

Another element of the invention is a method for evaluating data which are transmitted via a bus system using a programmable mobile evaluation unit whose memory can store the data from the bus system. The evaluation unit is preferably the inventive apparatus. Producing the program and loading the data require the steps below.

First, a program is written by using a programming language which has constructs for filtering the data and for determining states and events. This is preferably the programming language which is described further below. When the program has been developed, it is compiled, so that the program can be executed on the evaluation unit (processor). Generally, special compilers are used which perform optimization such that the short response times and reaction times are achieved which are required in order to analyse the high level of data traffic on the bus. The externally compiled program is transferred to the evaluation unit via the interfaces described. The apparatus is preferably designed such that the program is called automatically after it has been loaded or whenever the vehicle is started later, in order to carry out the analysis activity. As soon as the events have frozen the content of the memory, a report—which can also be visual—is produced. It is now possible to start downloading the collected data.

When the collected data have been downloaded, further analysis tools are available—these generally involve software which conditions the information in various forms. It is thus possible to produce multidimensional depictions in the form of curves, histograms or mountain ranges.

The different forms of transmission of the collected data to the base station have already been described above. The transmission of data can also be made dependent on whether particular events have occurred.

Another important element of the invention is the programming language for controlling the apparatus described. This programming language comprises two fundamental constructs. First, it is a construct which describes the data which need to be filtered and hence need to be stored at least intermittently. Secondly, it is a construct which makes it possible to specify relevant states and events.

The filter construct allows the messages to be filtered according to their header and according to their content. The header generally determines the significance and origin of the packet. The content can have different significances depending on the protocol. It is also possible to use the construct to determine data which are sent to the bus when simulating the situation.

The individual types of states and events have already been described above. They can also be found in the subclaims. The naming of these features is self-explanatory.

The ascertained states and events are generally used to control programmable start and stop trigger criteria for each memory. They can be related to one another as desired by operators. The constructs for this are logic and arithmetic operators. States and events are stored using data structures. Such data structures are provided on the basis of the type of events.

Further program constructs are used to send CAN messages for particular events. This means that a bus user which is actually present can be controlled or a bus user which is not present can be simulated.

Classification functions such as MinMax (minimum and maximum value of a variable), Count (frequency of the occurrence of a criterion) and Timer (dwell time or active time of a criterion), which can also take into account a plurality of dimensions, can be used to collect and to correlate data-related findings.

A further program construct, such as is already known from other programming languages (include), makes it possible to load macro definitions, such as packet identifiers. These packet identifiers are different for every vehicle, but they are provided by the manufacturer, which means that decoding is possible. The use of the macro definitions makes it possible to use the same program code (after compiling) for different vehicles.

Another element of the invention is an evaluation unit which uses a wireless connection to communicate with the inventive apparatus. For communication, the apparatus is preferably connected to a base station, the base station using a wireless connection to interchange information with the inventive data logger. This apparatus is preferably a conventional PC which is connected to the inventive apparatus via a wireless LAN. Communication preferably takes place using known protocols (IP). The protocol based on IP is not standardized. However, it is also possible in this case to use a known ftp protocol. In addition, the evaluation unit can be designed such that it first checks whether particular events have occurred before the data are loaded. In another embodiment, it is likewise possible for the inventive apparatus for logging data not to permit a connection to be set up if particular events have not occurred.

To be able to transmit large volumes of data, the evaluation unit checks whether sufficiently high bandwidth is available before data transmission is started. The evaluation unit is thus constantly checking the network with its base stations in order to discover whether new data loggers have registered.

In another embodiment, transmission takes place under the protection of passwords, with the individual items of interchanged information additionally being able to be encrypted.

### DETAILED DESCRIPTION

The invention is explained in more detail below using exemplary embodiments which are shown schematically in the figures. Identical reference numerals in the individual figures denote identical elements in this context. Specifically,

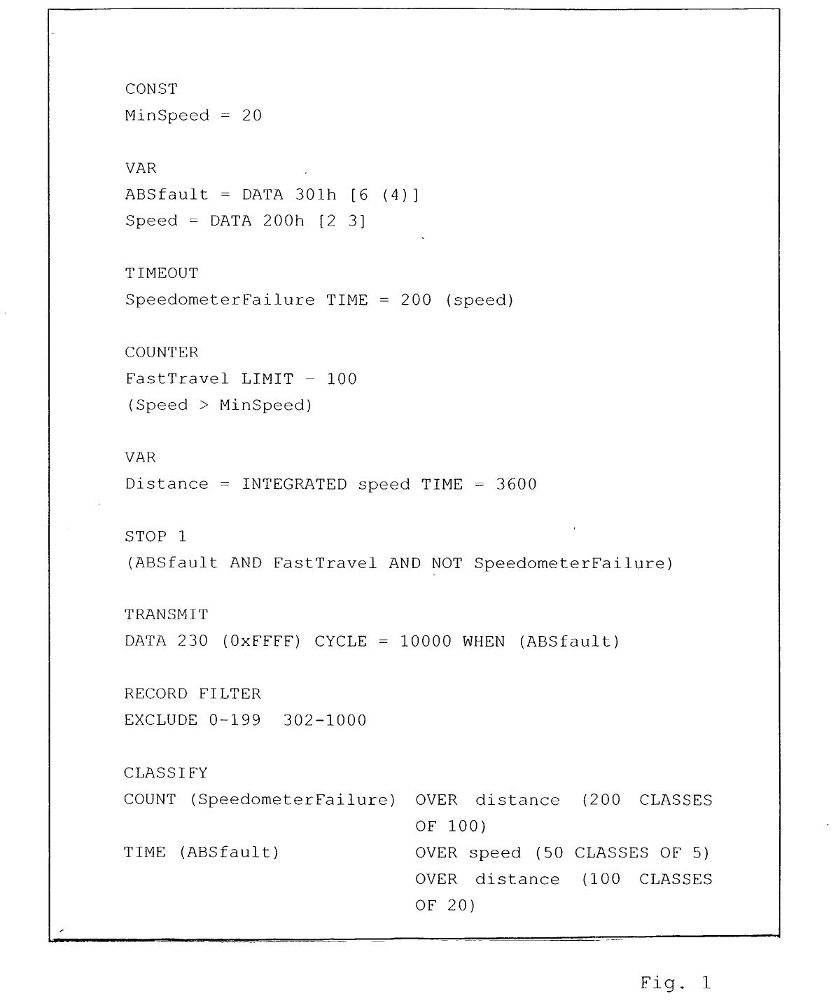

FIG. 1 shows an example program which uses the fundamental components of the programming language;

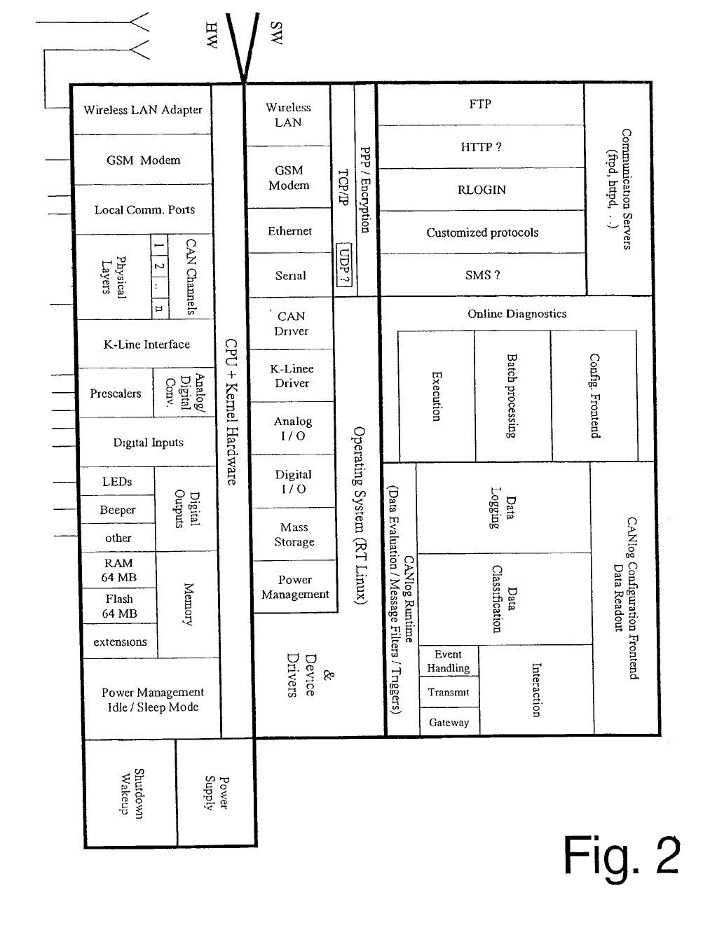

FIG. 2 shows the schematic design of the inventive apparatus, which is based on a Realtime Linux (RT-Linux), with both software and hardware components being shown;

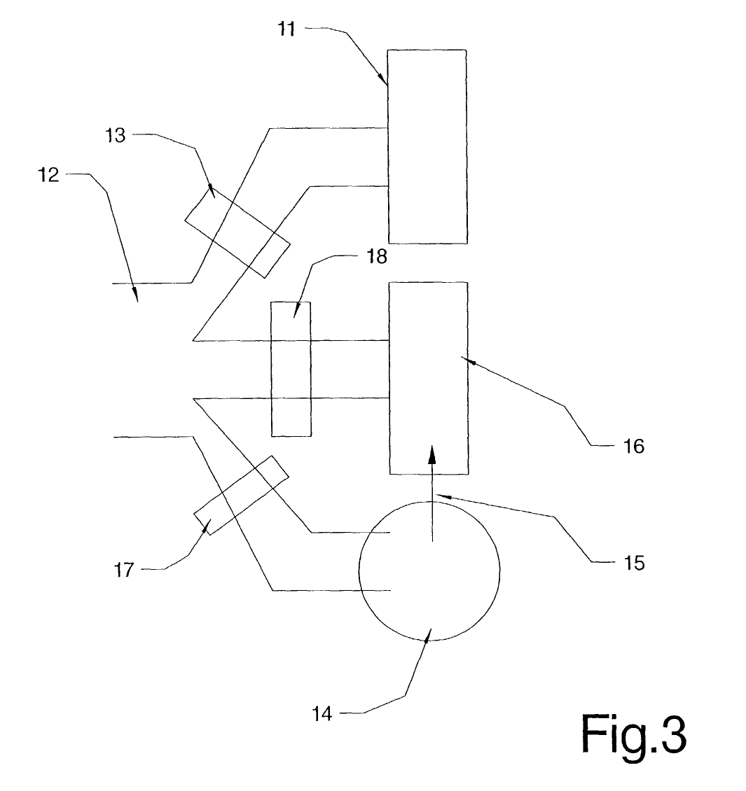

FIG. 3 shows the schematic splitting of the flow of data on the bus and the storage of the individual items of information, and also control of the memories by the program.

FIG. 1 shows a program which comprises various blocks.

The aim is to collect data about failures in the antilock system (ABS) which occur above a particular minimum speed. In this context, the speedometer must not have failed, however, since the, speed information is otherwise meaningless. If the antilock system reports a fault, the speedometer is working properly and the minimum speed has been exceeded, then the memory needs to be frozen. Every 10 seconds, impending fault reports from the antilock system need to be deleted by sending an appropriate packet. Only particular packets are recorded, not the entire bus traffic. In addition, classifications are made which store the number of speedometer failures in relation to the distance and the duration of failures in the antilock system over the speed travelled.

The constant stipulates the minimum speed as 20 km/h. The data packets with the header 301h contain, in data byte 6 at bit position 4, the information about a fault in the antilock system. The speed travelled is transmitted in the packet having the header 200h in bytes 2 and 3.

Speedometer failure has occurred whenever no speed packet has been sent over the time period of 200 time units.

Persistently fast travel (“FastTravel”) is in progress whenever the data packet containing the speed information has been received at least 100 times in succession and the speed travelled is always over the minimum speed. The distance is calculated as the integral over the speed, with all 3600 time units being integrated.

The memory is frozen whenever a fault in the antilock system is reported and the vehicle is at the same time travelling persistently fast and the speedometer has not failed.

If the antilock system reports a fault, a packet containing the header 230 and the correspondingly set data bytes is sent no later than every 10000 time units, which results in the antilock system rescinding the fault indication.

The instruction RECORDFILTER excludes the packets from 0 to 199 and 302 to 1000 from the recording. The packets between 200 and 301 are, by contrast, stored in the memory area. All speedometer failures are classified (counted) over the distance; a second classification records the duration of all faults in the antilock system over the speed travelled and over the distance. The results of this classification can thus be represented in a two-dimensional graph.

FIG. 2 shows the basic design of the inventive apparatus, with both the hardware layers and the individual software layers being described. Since the drawing is self-explanatory, only a few modules are mentioned.

The figure clearly shows the interface between the hardware and software, with the software which provides appropriate drivers for the individual hardware components being arranged above the CPU. Arranged on these drivers is the operating system, which uses the drivers to access the hardware. In the preferred case, the operating system is Realtime Linux, which is predestined for this task on account of its guaranteed response times. As the bandwidths on the bus systems increase and as the number of bus systems monitored simultaneously in the vehicle increases, it is necessary to use an operating system which provides guaranteed response times. Some areas are accessed directly by the operating system, such as the memory. It can clearly be seen that a plurality of CAN bus systems can be monitored simultaneously. The software is divided into a log area and a classification area. This is often a program which is compiled before being transferred to the system. This program generally accesses libraries, which can be connected to the program either statically or dynamically on the system.

In the execution area, the actual program which uses the individual filters is executed.

FIG. 3 shows the flow 12 of data and the branching thereof into the individual memory areas 11 and 16. In this context, the individual data items are filtered, the filters 13, 18 and 17 corresponding to individual program constructs.

The memory area 11 is used for storing classification data. The corresponding program construct can be found in FIG. 1. This memory stores one-dimensional or multidimensional data items in relation to one another. The memory area 16 is used for storing the individual packets which have been let through by the RECORDFILTER. This memory is an FIFO memory. The corresponding identical program construct can be found in FIG. 1. The memory area 16 is controlled by the event 15, namely STOP or START. The processing unit 14 processes the data packets and produces therefrom, on the basis of the program, states and events which are used by the commands. The processing unit 14 thus likewise filters the information. This filter process is illustrated by the symbol 17. Only the data packets which the program also needs for calculations are filtered out of the bus traffic.

1. An apparatus for logging information on at least one bus system, particularly in a CAN system,
having an interface to the bus system, wherein said interface can be used to analyse data traffic on the bus system,
having a processing unit which filters determinable data from the data traffic in order to store these data in a memory,
having a communications unit which permits wireless communication in order to transmit the data, preferably, stored in the memory,
having a housing, wherein said housing and containing components are of such a size that mobile use, particularly in a motor vehicle, is possible.

2. The apparatus according to the claim 1, wherein the communications unit is designed such that a connection is automatically set up in the vicinity of transmitters in order to transmit the data held in the memory.

3. The apparatus according to the claim 2, wherein communication takes place by radio, preferably using one or more of the following protocols UMTS, GSM, GRPS, Bluetooth, Wireless Lan or using infrared.

4. The apparatus according to the claim 1, wherein the processing unit records the flow of information on the bus system in a discrete period of time, wherein the specific period of time progresses continuously and wherein the memory being managed by an FIFO rule.

5. The apparatus according to the claim 1, wherein an interface is used to transmit a compiled program which stipulates what information needs to be filtered and what events need to be taken into account.

6. The apparatus according to the claim 1, wherein the program is divided into two sections, the first section undertaking the filtering of the data and writing particular data to the memory, and the second section using the data to evaluate whether particular states or events have occurred.

7. The apparatus according to the claim 6, wherein the states and/or events comprise variables, timers, counters, timeouts, flags, message rates, time integrals, reception events and/or time-controlled events which can be connected by functions such as conditions or logic and/or arithmetic operators and can be stored in data structures, and in that the filtering system comprises recording filters, reproduction filters and/or, if there are a plurality of buses, gateway filters which include or exclude data having particular identifiers.

8. Apparatus for mobile logging of information on at least one bus system, particularly in a CAN system,
having an interface to the bus system, wherein said interface can be used to analyse data traffic on the bus system,
having a processing unit which filters out data on the basis of programmable filter rules in order to store these data in a memory, and which freezes the state of the memory on the basis of programmable states and/or events, particularly by producing a copy of the content of the memory,
having a housing, where the housing and the containing components are of such a size that mobile use, particularly in a motor vehicle, is possible.

9. The apparatus according to the claim 8, wherein the processing unit records the flow of information on the bus system in a discrete period of time, wherein the specific period of time progresses continuously and wherein the memory being managed by an FIFO rule.

10. The apparatus according to the claim 8, wherein an interface is used to transmit a compiled program which stipulates what information needs to be filtered and what events need to be taken into account.

11. The apparatus according to the claim 8, wherein the program is divided into two sections, the first section undertaking the filtering of the data and writing particular data to the memory, and the second section using the data to evaluate whether particular states or events have occurred.

12. The apparatus according to the claim 11, wherein the states and/or events comprise variables, timers, counters, timeouts, flags, message rates, time integrals, reception events and/or time-controlled events which can be connected by functions such as conditions or logic and/or arithmetic operators and can be stored in data structures, and in that the filtering system comprises recording filters, reproduction filters and/or, if there are a plurality of buses, gateway filters which include or exclude data having particular identifiers.

13. A method for evaluating data which are transmitted via a bus system using a programmable mobile evaluation unit whose memory can store the data from the bus system, having the following steps:
a program in a relatively high-level programming language is edited using constructs for filtering the data and for determining states and/or events,
the program is compiled, so that the program can be executed on the evaluation unit,
the program is transmitted to the evaluation unit via an interface,
the collected data from the bus system are loaded from the memory when the program has been executed.

14. The method according to the claim 13, wherein the states and/or events comprise variables, timers, counters, timeouts, flags, message rates, time integrals, reception events and/or time-controlled events which can be connected by functions such as conditions or logic and/or arithmetic operators and can be stored in data structures, and in that the filtering system comprises recording filters, reproduction filters and/or, if there are a plurality of buses, gateway filters which included or exclude data having particular identifiers.

15. The method according to the claim 13, wherein the data in the memory are transmitted wirelessly, it being possible to take into account the occurrence of particular events.

16. The method according to the claim 15, wherein a check is carried out to determine whether a base station is available, with authorizations being able to be checked and the data to be transmitted being able to be encrypted.

17. The method according to the claim 13, wherein communication takes place by radio, preferably using one or more of the following protocols: UMTS, GSM, GRPS, Bluetooth, Wireless Lan or using infrared, with protocols such as TCP/IP being used.

18. Computer loadable data structure representing a compiler or interpreter for a programming language for controlling an apparatus for logging information on at least one bus system, particularly in a CAN system, comprising program constructs
which allow specification of the data which need to be filtered and thus need to be stored at least intermittently,
which allow specification of states and/or events, the states and/or events comprising variables, timers, counters, timeouts, flags, message rates, time integrals, reception events and/or time-controlled events.

19. The computer loadable data structure according to the claim 18, wherein the states and/or events can be related to one another by operators, and data structures can be defined which can store information for a relatively long period of time.

20. The computer loadable data structure according to the claim 18, wherein the specification of filters comprises recording filters, reproduction filters and/or, if there are a plurality of buses, gateway filters which include or exclude data having particular identifiers.

21. The computer loadable data structure according to the claim 18, wherein a program construct is available which permits the reading of macro definitions for packet identifiers.

22. Evaluation unit which uses a wireless connection to communicate with an apparatus for logging information on at least one bus system, particularly in a CAN system, having a memory area which can store the logged information, comprising means, particularly protocol controlling means, which, following setup of a connection, retrieve the filtered information from the memory area in the apparatus for logging.

23. The evaluation unit according to the claim 22, wherein a connection is set up whenever an apparatus for logging is in a reception range which permits a high level of data transmission.

24. The evaluation unit according to the claim 22, wherein information is transmitted only if there is a particular event, particularly a fault state.

25. The evaluation unit according to the claim 22, wherein transmission takes place in encrypted form, the information being able to be retrieved from the memory area only if particular identifiers have been interchanged.

26. The evaluation unit according to the claim 22, wherein communication takes place by radio, preferably using one or more of the following protocols UMTS, GSM, GRPS, Bluetooth, Wireless Lan or using infrared, with protocols such as TCP/IP being used.
